(19) United States
(12) Patent Application Publication
(10) Pub. No.: US 2009/0310285 A1
(43) Pub. Date: Dec. 17, 2009

(54) PROCESS FOR PREPARING POLYTHIOPHENES

(75) Inventors: Knud Reuter, Krefeld (DE); Stephen Kirchmeyer, Leverkusen (DE); Udo Merker, Koln (DE); Peter Wilfried Loevenich, Koln (DE); Timo Meyer-Friedrichsen, Krefeld (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/441,738

(22) PCT Filed: Sep. 19, 2007
(86) PCT No.: PCT/EP2007/059908

§ 371 Date: Apr. 1, 2009

(30) Foreign Application Priority Data
Sep. 20, 2006 (DE) 10 2006 044 067.6

(51) Int. Cl. H01G 9/025; C08F 4/32; C08F 2/04; B05D 5/12; H01G 9/02

(52) U.S. Cl. 361/523; 526/227; 526/230; 526/230.5; 526/223; 526/193; 526/220; 427/58; 252/62.2

(57) ABSTRACT

The invention relates to a process for preparing polythiophene dispersions or for in situ deposition of polythiophenes. The dispersion is prepared by oxidative polymerizing of a thiophene or thiophene derivative, wherein an oxidizing agent is used and is at least one organic peroxidic compound excluding diacyl peroxide. The invention also relates to the use of specific organic peroxides as oxidizing agents in the oxidative polymerization of thiophenes. The invention further relates to a process to process a conductive layer and the use of the conductive layer.

The invention relates to a novel process for preparing polythiophenes, especially conductive polythiophenes, and to the use of specific peroxidic compounds as oxidizing agents in the oxidative polymerization of thiophenes.

The compound class of the n-conjugated polymers has been the subject of numerous publications in the last few decades. They are also referred to as conductive polymers or as synthetic metals.

Conductive polymers are gaining increasing economic significance, since polymers have advantages over metals with regard to processibility, weight and the controlled establishment of properties by chemical modification. Examples of known π-conjugated polymers are polypyrroles, polythiophenes, polyanilines, polyacetylenes, polyphenylenes and poly(p-phenylene-vinylenes). Layers of conductive polymers have various industrial uses.

Conductive polymers are prepared by chemical or electrochemical oxidative means from precursors for the preparation of conductive polymers, for example, optionally substituted thiophenes, pyrroles and anilines and their particular derivatives which may be oligomeric. Chemically oxidative polymerization in particular is widespread, since it can be achieved in a technically simple manner in a liquid medium or on various substrates.

A particularly important and industrially utilized polythiophene is poly(ethylene-3,4-dioxythiophene) which, in its oxidized form, has very high conductivities and is described, for example, in ESP 339 340 A2. An overview of numerous poly(alkylene-3,4-dioxythiophene) derivatives, especially poly(ethylene-3,4-dioxythiophene) derivatives, their monomer units, syntheses and applications, is given by L. Groenendaal, F. Jonas, D. Freitag, H. Pielartzik and J. R. Reynolds, Adv. Mater. 12, (2000), p. 481-494.

Oxidizing agents for preparing poly(ethylene-3,4-dioxythiophene) (PEDT or PEDOT, referred to hereinafter as PEDT) from ethylene-3,4-dioxythiophene (EDT or EDOT, referred to hereinafter as EDT) which are common in industry and/or specified in the literature and patent literature stem, for example, from the classes of the inorganic peroxidic compounds or of the transition metal salts.

Prior art inorganic peroxidic compounds suitable as oxidizing agents are, for example, hydrogen peroxide, sodium perborate, persulfates (peroxodisulfates) of the alkali metals, such as sodium persulfate or potassium persulfate, or ammonium persulfate. Oxidation with air or oxygen proceeds in a chemically related manner.

Such oxidizing agents are suitable particularly for preparing polythiophene dispersions, especially poly(ethylene-3,4-dioxythiophene) dispersions, as described in EP-A 440 957. Such aqueous dispersions preferably contain polymeric sulfonic acids as polyanions, which assume the role of the counterions for the poly(ethylene-3,4-dioxythiophene) cations.

A disadvantage of the inorganic peroxidic oxidizing agents with the exception of hydrogen peroxide is the restriction to aqueous systems. They are thus unsuitable for preparing conductive polymers by in situ polymerization from organic solution. Furthermore, in the case of many of these oxidizing agents, there exists a tendency to oxidize the sulfur atoms of the thiophene ring, which can lead under some circumstances to a limit in the achievable electrical conductivity or to the formation of by-products. With H₂O₂, for the reasons stated, neither an aqueous high-conductivity PEDT:PSS dispersion nor a high-conductivity layer polymerized in situ from alcoholic H₂O₂ solution can be obtained.

Prior art transition metal salts suitable as oxidizing agents are, for example, iron(III) salts such as FeCl₃, iron(III) perchlorate, iron(III) sulfate, iron(III) tosylate or other iron(III) sulfonates, for example iron(III) camphorsulfonate, cerium(IV) salts, potassium permanganate, potassium dichromate or copper(II) salts such as copper (II) tetrafluoroborate.

A disadvantage of oxidizing agents based on such transition metal salts is the formation of salts of these metals in lower oxidation states (for example Fe(II) salts, Mn(IV) compounds, Cu(I) salts) as inevitable by-products. In the case of industrial use of conductive layers which are produced on the basis, for example, of EDT and Fe(III) salts, for example for use in capacitors, these salts or the transition metal ions in lower oxidation states remaining in the conductive layer can be disruptive and generally have to be washed out as completely as possible. For this purpose, several washing operations are often required. Otherwise, the crystallization of the salts in the course of time can lead to an increased series resistance as a result of contact resistances which occur. In addition, the crystals can damage the dielectric or the outer contact layers in the case of mechanical stress on the capacitor, such that the residual current rises.

US-A 20060062958 describes the use of benzoyl peroxide as an organic peroxide as an oxidizing agent for polymerizing monomers. However, the use of diacyl peroxides such as benzoyl peroxide leads, with different experimental conditions, to polymers with low conductivity or to incomplete polymerization with poor film formation.

Allemand describes, in US-A 20060065889, the oxidative polymerization of monomers with the aid of organic peroxides to obtain a solution of a conductive polymer. In the case of EDT as the monomer, the procedure described leads to a polymer solution with significantly altered optical properties and a lower conductivity compared to conventionally prepared polymer. The procedure and the product properties lead to the conclusion that the process described leads to overoxidation of the polymer, which results in a reduction in the conductivity.

There is thus a need for oxidizing agents for preparing polythiophenes by means of chemical oxidative polymerization which do not have the disadvantages mentioned.

It was an object of the present invention to discover suitable oxidizing agents for the oxidative polymerization of thiophenes, for example for preparing polythiophene dispersions or for in situ deposition of polythiophenes, and more particularly to provide a process for preparing polythiophenes by means of chemically oxidative in situ polymerization, no subsequent complete removal of transition metal ions being required.

This object was surprisingly found through the use of specific organic peroxidic compounds as oxidizing agents for the preparation of polythiophenes by means of oxidative polymerization. In the case of use of the specific organic peroxidic compounds, only very small amounts of additional catalysts containing transition metal ions are required, for example Fe, Co, Ni, Ce, V, Zr ions in the form of soluble salts (for example of the tosylates), preferably Fe(II), Fe(III), Co(II) and Co(III) ions. Another means of catalytically accelerating the peroxide reaction consists in adding small amounts of tertiary amines, for example the compounds known from UP resin technology, such as N,N-dimethylaniline, N,N-diethylaniline, the corresponding toluidines or chloroanilines, and if appropriate also N,N-bis(hydroxyethyl)anilines and polymeric derivatives thereof. There is thus no need for a complete and complicated removal of transition metal ions.

The present invention thus provides a process for preparing polythiophenes by oxidatively polymerizing thiophenes or thiophene derivatives to prepare polythiophene dispersions or to deposit polythiophenes in situ, characterized in that the oxidizing agent used is at least one organic peroxidic compound, this organic peroxidic compound not being a diacyl peroxide.

Preferably, in the process according to the invention, polythiophenes containing repeat units of the general formula (I)

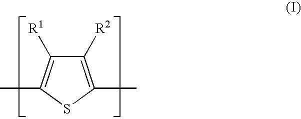

in which
R¹ and R² are each independently H, an optionally substituted C₁-C₁₈-alkyl radical or an optionally substituted C₁-C₁₈-alkoxy radical, or
R¹ and R² together are an optionally substituted C₁-C₈-alkylene radical, an optionally substituted C₁-C₈-alkylene radical in which one or more carbon atom(s) may be replaced by O, preferably a C₁-C₈-dioxyalkylene radical, or are an optionally substituted propene-1,3-diyl radical in which the C-3 atom may optionally be replaced by a heteroatom selected from O and S,
   are prepared by oxidative polymerization of thiophenes of the general formula (II)

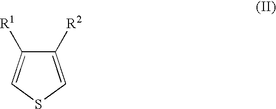

in which R¹ and R² are each as defined for the general formula (I).

More preferably, in the process according to the invention, polythiophenes containing repeat units of the general formula (I-a) and/or (I-b)

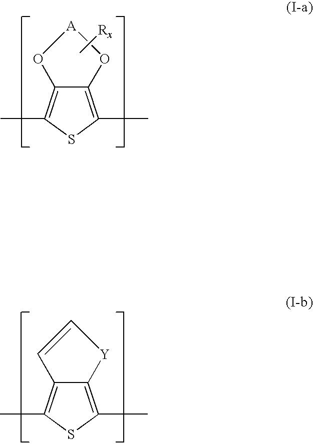

in which
A is an optionally substituted C₁-C₅-alkylene radical, preferably an optionally substituted C₂-C₃-alkylene radical,
Y is O or S, preferably S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 to 8, preferably 0 or 1, and,
   in the case that a plurality of R radicals are bonded to A, they may be the same or different,
   are prepared by oxidatively polymerizing thiophenes of the general formula (II-a) and/or (II-b)

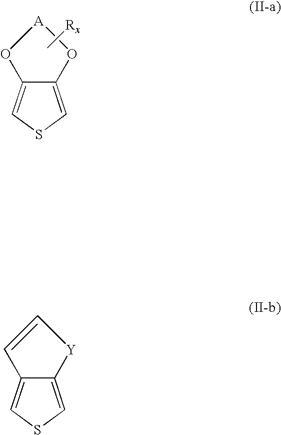

in which A, Y, R and x are each as defined for the general formulae (II-a) and (II-b).

The general formula (I-a) should be understood such that x substituents R may be bonded to the alkylene radical A.

Polythiophenes containing repeat units of the general formula (I-a) are preferably those containing repeat units of the general formula (I-a-1)

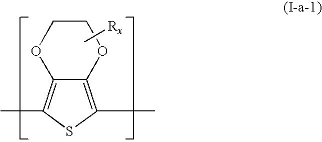

in which

R and x are each as defined above.

These are more preferably those polythiophenes containing repeat units of the general formula (I-aa-1)

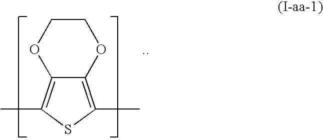

In particularly preferred embodiments, the polythiophene with repeat units of the general formula (I-a) and/or (I-b) is poly(3,4-ethylenedioxythiophene) or poly(thieno [3,4-b]thiophene), i.e. a homopolythiophene formed from repeat units of the formula (I-aa-1) or (I-b).

In further particularly preferred embodiments, the polythiophene with repeat units of the general formula (I-a) and/or (I-b) is a copolymer formed from repeat units of the formula (I-aa-1) and (I-b).

The polythiophenes may be uncharged or cationic. In preferred embodiments, they are cationic, “cationic” relating only to the charges which reside on the polythiophene main chain. According to the substituent on the R radicals, the polythiophenes may bear positive and negative charges in the structural unit, in which case the positive charges are present on the polythiophene main chain and the negative charges may be present on the R radicals substituted by sulfonate or carboxylate groups. In this case, the positive charges of the polythiophene main chain may be partly or fully balanced by any anionic groups present on the R radicals. Viewed overall, the polythiophenes in these cases may be cationic, uncharged or even anionic. Nevertheless, they are all considered to be cationic polythiophenes in the context of the invention, since the positive charges on the polythiophene main chain are crucial. The positive charges are not shown in the formulae, since their exact number and position cannot be determined readily. The number of positive charges is, however, at least 1 and at most n, where n is the total number of all repeat units (identical or different) within the polythiophene.

Preference is given to using the process according to the invention to prepare conductive polythiophenes with a specific conductivity of more than 10⁻³ Scm⁻¹, more preferably of 10⁻² Scm⁻¹.

To compensate for the positive charge, where this is not already done by the optionally sulfonate- or carboxylate-substituted and hence negatively charged R radicals, the cationic polythiophenes require anions as counterions.

Preference is given to carrying out the process according to the invention in the presence of at least one counterion.

Useful counterions include monomeric or polymeric anions, the latter also referred to hereinafter as polyanions.

Preferred polymeric anions are, for example, anions of polymeric carboxylic acids, such as polyacrylic acids, polymethacrylic acids or polymaleic acids, or polymeric sulfonic acids, such as polystyrenesulfonic acids and polyvinylsulfonic acids. These polycarboxylic acids and polysulfonic acids may also be copolymers of vinylcarboxylic acids and vinylsulfonic acids with other polymerizable monomers, such as acrylic esters and styrene. They may, for example, also be partly fluorinated or perfluorinated polymers containing SO₃⁻M⁺ or COO⁻M⁺ groups, where M⁺ is, for example, ⁺, Li⁺, Na⁺, K⁺, Rb⁺, Cs⁺ or NH₄⁺, preferably H⁺, Na⁺, or K⁺. Such a partly fluorinated or perfluorinated polymer containing SO₃⁻M⁺ or COO⁻M⁺ groups may, for example, be Nafion® which is, for example, commercially available. Mixtures of one or more of these polymeric anions are also useful.

Particular preference is given, as the polymeric anion, to the anion of polystyrenesulfonic acid (PSS) as the counterion.

The molecular weight of the polyacids which afford the polyanions is preferably from 1000 to 2 000 000, more preferably from 2000 to 500 000. The polyacids or their alkali metal salts are commercially available, for example polystyrenesulfonic acids and polyacrylic acids, or else are preparable by known processes (see, for example, Houben Weyl, Methoden der organischen Chemie [Methods of organic chemistry], Vol. E 20, Makromolekulare Stoffe [Macromolecular Substances], Part 2, (1987), p. 1141 ff.)

The monomeric anions used are, for example, those of C₁-C₂₀-alkanesulfonic acids, such as those of methanesulfonic acid, ethanesulfonic acid, propane-sulfonic acid, butanesulfonic acid or higher sulfonic acids, such as those of dodecanesulfonic acid, of aliphatic perfluorosulfonic acids, such as those of trifluoromethanesulfonic acid, of perfluorobutane-sulfonic acid or of perfluorooctanesulfonic acid, of aliphatic C₁-C₂₀-carboxylic acids such as those of 2-ethylhexylcarboxylic acid, of aliphatic perfluoro-carboxylic acids, such as those of trifluoroacetic acid or of perfluorooctanoic acid, and of aromatic sulfonic acids optionally substituted by C₁-C₂₀-alkyl groups, such as those of benzenesulfonic acid, o-toluene-sulfonic acid, p-toluenesulfonic acid, dodecylbenzene-sulfonic acid, dinonylnaphthalenesulfonic acid or dinonylnaphthalenedisulfonic acid, and of cycloalkane-sulfonic acids such as camphorsulfonic acid or tetrafluoroborates, hexafluorophosphates, perchlorates, hexafluoroantimonates, hexafluoroarsenates or hexa-chloroantimonates.

Particular preference is given to the anions of p-toluenesulfonic acid, methanesulfonic acid or camphorsulfonic acid.

It is also possible for anions of the oxidizing agent used or anions formed therefrom after the reduction to serve as counterions, such that an addition of additional counterions is not absolutely necessary.

Cationic polythiophenes which contain anions as counterions for charge compensation are often also referred to in the technical field as polythiophene/(poly)anion complexes.

Preferred thiophenes of the general formula (II-a) are those of the general formula (II-a-1)

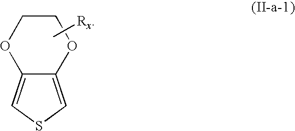

The thiophenes of the general formula (II-a) used are more preferably those of the general formula (II-aa-1)

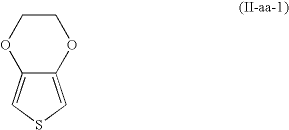

In the context of the invention, derivatives of the thiophenes detailed above are understood to mean, for example, dimers or trimers of these thiophenes. Higher molecular weight derivatives, i.e. tetramers, pentamers, etc., of the monomeric precursors are also possible as derivatives. The derivatives can be formed either from identical or different monomer units and be used in pure form and also in a mixture with one another and/or with the abovementioned thiophenes. Oxidized or reduced forms of these thiophenes and thiophene derivatives are also encompassed by the term “thiophenes” and “thiophene derivatives” within the context of the invention, provided that the same conductive polymers form when they are polymerized as in the case of the thiophenes and thiophene derivatives detailed above.

Processes for preparing the thiophenes and derivatives thereof are known to those skilled in the art and are described, for example, in L. Groenendaal, F. Jonas, D. Freitag, H. Pielartzik and J. R. Reynolds, Adv. Mater. 12 (2000), p. 481-494 and literature cited therein.

The thiophenes can optionally be used in the form of solutions. Suitable solvents include in particular the following organic solvents which are inert under the reaction conditions: aliphatic alcohols such as methanol, ethanol, i-propanol and butanol; aliphatic ketones such as acetone and methyl ethyl ketone; aliphatic carboxylic esters such as ethyl acetate and butyl acetate; aromatic hydrocarbons such as toluene and xylene; aliphatic hydrocarbons such as hexane, heptane and cyclohexane; chlorohydrocarbons such as dichloromethane and dichloroethane; aliphatic nitrites such as acetonitrile, aliphatic sulfoxides and sulfones such as dimethyl sulfoxide and sulfolane; aliphatic carboxamides such as methyl acetamide, dimethyl acetamide and dimethyl formamide; aliphatic and araliphatic ethers such as diethyl ether and anisole. In addition, it is also possible to use water or a mixture of water with the aforementioned organic solvents as the solvent. Preferred solvents are alcohols and water, and also mixtures comprising alcohols or water or mixtures of alcohols and water.

Thiophenes which are liquid under the oxidation conditions can also be polymerized in the absence of solvents. C₁-C₅-alkylene radicals A are, in the context of the invention: methylene, ethylene, n-propylene, n-butylene or n-pentylene; C₁-C₈-alkylene radicals or additionally n-hexylene, n-heptylene and n-octylene. In the context of the invention, C₁-C₈-alkylidene radicals are C₁-C₈-alkylene radicals which contain at least one double bond and have been detailed above. In the context of the invention, C₁-C₈-dioxyalkylene radicals, C₁-C₈-oxythiaalkylene radicals and C₁-C₈-dithiaalkylene radicals are the C₁-C₈-dioxyalkylene radicals, C₁-C₈-oxythiaalkylene radicals and C₁-C₈-dithiaalkylene radicals corresponding to the C₁-C₈-alkylene radicals detailed above. In the context of the invention, C₁-C₁₈-alkyl represents linear or branched C₁-C₁₈-alkyl radicals, for example methyl, ethyl, n- or isopropyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl represents C₅-C₁₂-cycloalkyl radicals such as cyclopentyl, cyclohexyl, cycloheptyl, cyclooctyl, cyclononyl or cyclodecyl , C₅-C₁₄-aryl represents C₆-C₁₄-aryl radicals such as phenyl or naphthyl, and C₇-C₁₈-aralkyl represents C₇-C₁₈-aralkyl radicals, for example benzyl, o-, m-, p-tolyl, 2,3-, 2,4-, 2,5-, 2,6-, 3,4-, 3,5-xylyl or mesityl. In the context of the invention, C₁-C₁₈-alkoxy radicals are the alkoxy radicals corresponding to the C₁-C₁₈-alkyl radicals detailed above. The above enumeration serves to illustrate the invention by way of example and should not be considered to be exclusive.

Any further substituents of the above radicals may be numerous organic groups, for example alkyl, cycloalkyl, aryl, halogen, ether, thioether, disulfide, sulfoxide, sulfone, sulfonate, amino, aldehyde, keto, carboxylic ester, carboxylic acid, carbonate, carboxylate, cyano, alkylsilane and alkoxysilane groups, and also carboxamide groups.

In the context of the present invention, organic peroxidic compounds are understood to mean organic peroxides, hydroperoxides, peresters or percarboxylic acids with one peroxidic—O—O— group or possibly also a plurality thereof. In addition, organic peroxidic compounds in the context of the invention are also understood to mean derivatives or salts of peroxodi-sulfuric acid H₂S₂O₈ or of Caro's acid H₂SO₅, provided that they contain at least one organic radical in the form of an alkyl or aryl group or of an organically substituted ammonium or phosphonium ion.

Preferred organic peroxides are dialkyl peroxides such as di-tert-butyl peroxide, di-tert-amyl peroxide, and aromatically substituted dialkyl peroxides such as dicumyl peroxide and tert-butyl cumyl peroxide (III). Preferred organic peroxides are also those which contain a plurality of peroxy groups, such as bis(tert-butylperoxyisopropyl)benzene (IV), 2,5-bis(tert-butyl-peroxy)-2,5-dimethylhexane (V), 2,5-di(tert-butyl-peroxy)-2,5-dimethyl-3-hexyne (VI), 1,1-di(tert-butyl-peroxy)-3,3,5-trimethylcyclohexane (VII), 2,2-di(tert-butylperoxy)butane (VIII).

The compounds of the formulae (III) to (VIII) are shown by way of example hereinafter:

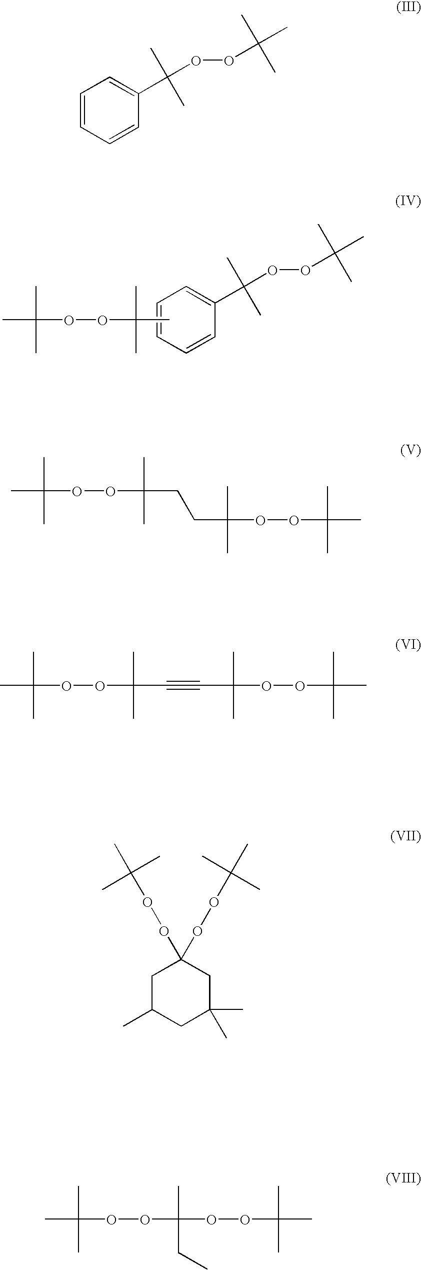

In addition, 3,3,5,7,7-pentamethyl-1,2,4-trioxepane (IX), as an example of a heterocyclic peroxide containing heteroatoms, such as O in this case, is one of the preferred peroxides.

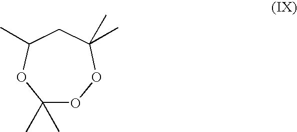

Preferred organic hydroperoxides are additionally alkyl hydroperoxides, such as tert-butyl hydroperoxide, tert-amyl hydroperoxide, or else aromatically substituted alkyl hydroperoxides such as cumyl hydroperoxide.

The group of preferred peroxides also includes the compounds classified as “ketone peroxides” through their designation introduced in the scientific literature and in the chemical trade, such as methyl ethyl ketone peroxide, methyl isopropyl ketone peroxide, methyl isobutyl ketone peroxide, cyclohexanone peroxide and acetylacetone peroxide. For these compounds, the literature discusses and reports different structures, it being possible for mixtures to be present and often also for peroxide and hydroperoxide structures to occur in the same molecule. Some structures are listed hereinafter by way of example, (X) to (XVI):

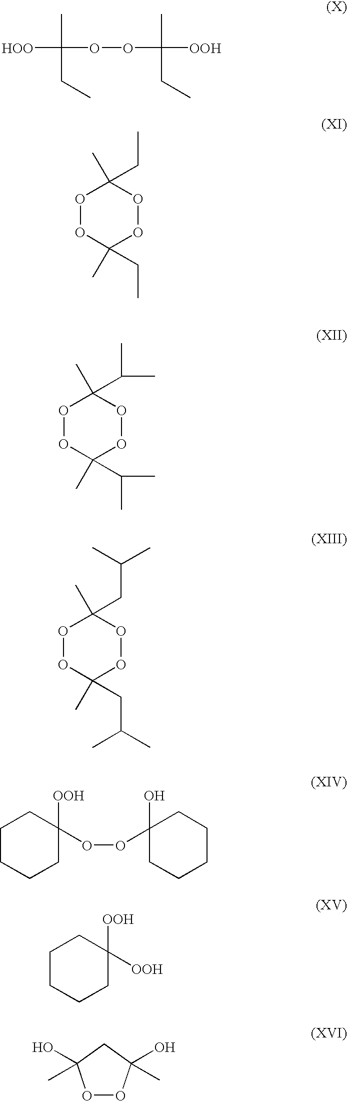

Preferred organic peroxidic compounds are additionally peresters, i.e., for example, esters of aliphatic or aromatic percarboxylic acids or organic percarbonates (esters of percarbonic acid). Examples include tert-butyl peroxy-2-ethylhexanoate (XVII), tert-butyl peroxy-3,5,5-trimethylhexanoate (XVIII), 2,5-dimethyl-2,5-di(2-ethylhexanoylperoxy)hexane (XIX), tert-butyl peroxybenzoate, tert-butyl monoperoxymaleate (XX), butyl 4,4′-di(tert-butyloxy)valerate (XXI), di(4-tert-butylcyclohexyl) peroxydicarbonate (XXII), tert-butyl peroxyisopropylcarbonate (XXIII).

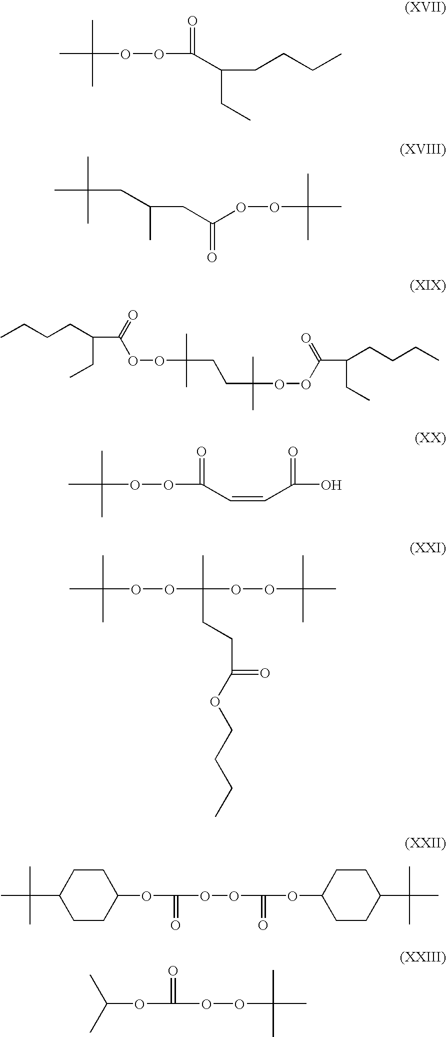

In addition, dimethyldioxirane (XXIV) is one of the preferred peroxides.

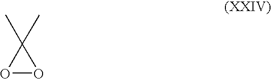

Furthermore, preferred organic peroxidic compounds are peracids (percarboxylic acids), for example peracetic acid, perpropionic acid, perbenzoic acid, m-chloro-perbenzoic acid, etc..

A further preferred group, which is suitable in accordance with the invention, of organic compounds with a peroxide function is that of organic salts of peroxodisulfuric acid (H₂S₂O₈) or of persulfuric acid (also known as Caro's acid, H₂SO₅). Organic salts are understood to mean all such salts whose cations from the group of the ammonium and the phosphonium ions possess at least one organic A radical, preferably 2 to 4, more preferably 4, organic A radicals, which, in the presence of a plurality of A radicals, may be the same or different. Examples of A include C₁- to C₁₈-alkyl radicals, e.g. methyl, ethyl, n-propyl, isopropyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, and also C₅-C₁₂-cycloalkyl radicals such as cyclopentyl, cyclohexyl, cycloheptyl, cyclooctyl, cyclononyl or cyclodecyl, and also C₆-C₁₄-aryl radicals such as phenyl or naphthyl, and C₇-C₁₈-aralkyl radicals, for example benzyl, o-, m-, p-tolyl, 2,3-, 2,4-, 2,5-, 2,6-, 3,4-, 3,5-xylyl or mesityl. Particular preference is given to organic ammonium salts of peroxodisulfuric acid (A₄N⁺)₂ S₂O₈²⁻, e.g. tetra-n-butylammonium peroxodisulfate.

According to the oxidizing agent used and polymerization time desired, the oxidative polymerization of the thiophenes of the formula (II) is undertaken generally at temperatures of from −10 to +250° C., preferably at temperatures of from 0 to 200° C., more preferably at temperatures of from 0 to 100° C. According to the batch size, polymerization temperature and oxidizing agent, the polymerization time may be from a few minutes up to several days. In general, the polymerization time is between 30 minutes and 150 hours.

The oxidative polymerization of the thiophenes of the formula (II) requires, in theoretical terms, 2.25 equivalents of oxidizing agent per mole of thiophene (seer for example, J. Polym. Sc. Part A, Polymer Chemistry Vol. 26, p. 1287 (1988)). However, it is also possible to use oxidizing agents in a smaller amount than that required theoretically. Preference is given to using thiophenes and oxidizing agents in a weight ratio of from 4:1 to 1:20. In preferred embodiments, the oxidizing agent is, however, employed in a certain excess, for example an excess of from 0.1 to 2 equivalents per mole of thiophene. Particular preference is thus given to using more than 2.25 equivalents of oxidizing agent per mole of thiophene. A peroxidic —O—O— group corresponds to two oxidation equivalents.

It is extremely surprising that the organic peroxidic compounds to be used in accordance with the invention lead to conductive layers with good conductivity, especially since this is not possible with diacyl peroxides. It is known, firstly, that particular peroxidic compounds can oxidize thiophenes to sulfoxides and sulfones, i.e only minor amounts, if any, of polythiophenes form (see, for example, Nakayama, Juzo; Nagasawa, Hidehiro; Sugihara, Yoshiaki; Ishii, Akihiko, Journal of the American Chemical Society (1997), 119(38), 9077-9078 or Nakayama, Juzo, Bulletin of the Chemical Society of Japan (2000), 73(1), 1-17). EDT is also known to react with peroxidic compounds under some circumstances leading to products other than polythiophenes, e.g. thiolactones (Kirchmeyer, Stephan; Reuter, Knud; Journal of Materials Chemistry (2005), 15(21), 2077-2088).

Moreover, it is known from numerous studies that peroxidic compounds are capable of oxidizing alcohols to carbonyl compounds and/or carboxylic acids, whereas, surprisingly, in accordance with the present invention, especially alcohols or mixtures comprising alcohols, in preferred embodiments, constitute very suitable solvents for the oxidative polymerization of the thiophenes.

The oxidative polymerization of polythiophenes in the process according to the invention can be used for different applications of the resulting thiophenes. It is, for example, possible to prepare stable dispersions comprising polythiophenes or else to directly, i.e. by means of in situ polymerization, produce conductive layers comprising polythiophenes, each of which is amenable to numerous further applications.

The invention accordingly further provides for the use of organic peroxidic compounds excluding diacyl peroxides for oxidative in situ polymerization of thiophenes or the above-listed derivatives thereof or for preparing dispersions comprising optionally substituted polythiophenes by oxidative polymerization of optionally substituted thiophenes or thiophene derivatives. Particular preference is given to the use of organic salts, especially tetraalkylammonium salts, of peroxodisulfuric acid. The latter are particularly suitable especially for in situ polymerization.

The present invention thus further provides a process for preparing dispersions comprising optionally substituted polythiophenes by oxidatively polymerizing optionally substituted thiophenes or thiophene derivatives in the presence of at least one solvent and optionally of at least one counterion, characterized in that the oxidizing agent used is at least one organic peroxidic compound excluding diacyl peroxides.

For the polymerization, the thiophenes or derivatives thereof, oxidizing agent and optionally counterions are preferably dissolved in the solvent(s) and stirred at the intended polymerization temperature until the polymerization is complete.

The dispersions prepared may be aqueous or nonaqueous dispersions.

In a preferred embodiment, the solvent(s) is/are nonaqueous solvent(s). In these nonaqueous dispersions, it is likewise possible for small proportions, i.e. preferably less than 10% by weight, of water to be present. In the nonaqueous dispersions, the optionally substituted polythiophenes and counterions may be present either partially or completely in dissolved or dispersed form. All these forms are referred to as dispersions above and hereinafter in the context of this invention.

Thiophenes and counterions, especially in the case of polymeric counterions, are used in such an amount that counterion(s) and polythiophene(s) are present thereafter in a weight ratio of from 0.5:1 to 50:1, preferably from 1:1 to 30:1, more preferably from 2:1 to 20:1. The weight of the polythiophenes corresponds here to the initial weight of the monomers used under the assumption that there is complete conversion in the polymerization.

The present invention likewise further provides a process for producing conductive layers comprising optionally substituted polythiophenes, characterized in that optionally substituted thiophenes or thiophene derivatives are oxidatively polymerized on a suitable substrate with at least one organic peroxidic compound excluding diacyl peroxides as an oxidizing agent in the presence or absence of at least one solvent.

The latter process—often also referred to in the technical field as in situ polymerization—is, for example, also used to produce layers which are part of capacitors, for example to produce the solid electrolyte or the electrodes.

The substrate may, for example, be glass, ultrathin glass (flexible glass) or plastics to be coated correspondingly, in the form of shaped bodies or films, or else other shaped bodies to be coated, for example anodes of capacitors.

According to the intended application for the polythiophenes synthesized by the process according to the invention, the use of different organic peroxidic compounds may be advantageous.

For example, water-soluble organic hydroperoxides are suitable for the preparation of aqueous dispersions comprising the above-listed polythiophenes. Preference is given here to tert-butyl hydroperoxide. A particularly preferred dispersion preparable by this variant is an aqueous dispersion comprising poly(3,4-ethylenedioxythiophene) and polystyrenesulfonic acid (PEDT/PSS complex).

Organic peroxides soluble in nonaqueous solvents are suitable particularly for the preparation of nonaqueous dispersions or for the preparation of polythiophene layers polymerized in situ, preferably poly(3,4-ethylenedioxythiophene) layers (PEDT layers), which are typically obtained from organic solvents, optionally in the presence of suitable counterions or acids which supply counterions.

In the above-detailed processes for preparing dispersions and conductive layers, the polythiophenes already mentioned are obtained, and the thiophenes and derivatives thereof, specific organic peroxidic compounds, counterions, etc., which have been mentioned already, can be used. Areas of preference apply analogously.

Preferred nonaqueous solvents for the preparation of nonaqueous dispersions or polythiophene layers polymerized in situ may, for example, be alcohols such as methanol, ethanol, n-propanol, isopropanol, n-butanol, ethylene glycol, diethylene glycol, particular preference among these alcoholic solvents being given to ethanol and n-butanol. However, it is also possible to use solvents from the group of the aliphatic and aromatic hydrocarbons, such as hexane, heptane, octane, toluene or xylene, of the halogenated aliphatic or aromatic hydrocarbons, such as methylene chloride, chloroform, chlorobenzene or o-dichlorobenzene, and also ethers such as diethyl ether, diisopropyl ether, tert-butyl methyl ether, tetrahydrofuran (THF), dioxane or diglyme, amides such as dimethylformamide, dimethylacetamide or N-methylpyrrolidone, alone or in a mixture with alcohols. Water may also be present in a small proportion, i.e. preferably less than 5% by weight.

For the preparation of aqueous dispersions, it is likewise possible for small proportions, i.e. preferably less than 10% by weight, of the above solvents, especially alcohols, to be present in the water.

For the preparation of stable aqueous polythiophene dispersions, it is advantageous to use water-soluble counterions of those detailed above, preferably sulfonic acids, especially polymeric sulfonic acids, for example polystyrenesulfonic acid (PSS).

For the preparation of nonaqueous polythiophene dispersions or the in situ preparation of layers from organic solution, it is advantageous to use counterions sufficiently soluble in the solvents, preferably sulfonic acids. These advantageously may be monomeric counterions, for example p-toluenesulfonic acid, dodecylbenzenesulfonic acid or camphorsulfonic acid.

The processes according to the invention can preferably be used to produce solid electrolytes in capacitors. In principle, an electrolyte capacitor is produced as follows: first, for example, a powder with a high surface area is pressed and sintered to give a porous electrode body. It is also possible to etch metal foils in order to obtain a porous foil. The electrode body is then coated, for example by electrochemical oxidation, with a dielectric, i.e. an oxide layer. The thiophene or thiophene derivative is polymerized on the dielectric by means of the inventive oxidizing agent to give a conductive polymer which constitutes the solid electrolyte. A coating with readily conductive layers, such as graphite and silver, serves as an electrode to draw off the current. In the case of use of porous foils, these may, as is frequently customary in the case of aluminum capacitors, also be wound together with a second metallic foil which serves to draw off the current before the production of the solid electrolytes. Between the two foils is placed a separator foil in the course of the winding step. Finally, the capacitor is contact-connected and encapsulated.

In the electrolyte capacitor, the electrode material preferably constitutes a porous body with large surface area, for example in the form of a porous sinter body or of a roughened foil. This will also be referred to hereinafter as electrode body for short.

The electrode body covered with a dielectric is also referred to hereinafter as oxidized electrode body for short. The term “oxidized electrode body” also includes those electrode bodies which are covered with a dielectric which has not been produced by oxidation of the electrode body.

The electrode body covered with a dielectric and entirely or partly with a solid electrolyte is also referred to hereinafter as capacitor body for short.

To form the solid electrolyte, in addition to oxidizing agent, thiophene or thiophene derivatives, it is also possible to introduce counterions into the oxidized electrode body. Preference is given to monomeric or polymeric counterions listed above.

The catalysts introduced into the oxidized electrode bodies for the polymerization are small amounts of transition metal ions, for example Fe, Co, Ni, Ce, V, Zr ions in the form of soluble salts (for example of the tosylates), preferably Fe(II), Fe(III), Co(II) and Co(III) ions. Another means of catalytically accelerating the peroxide reaction consists in the addition of small amounts of tertiary amines, for example the compounds known from UP resin technology, such as N,N-dimethylaniline, N,N-diethylaniline, the corresponding toluidines or chloroanilines, and possibly also N,N-bis(hydroxyethyl)anilines and polymeric derivatives thereof.

The oxidizing agent, the thiophene or the thiophene derivative, if appropriate the counterions and the catalyst are preferably introduced into mixtures comprising one or more solvents. All or some of the polymerization reactants, oxidizing agents, thiophene or thiophene derivative, if appropriate counterions and catalyst can, however, also be introduced successively (sequentially) into the oxidized electrode body. For example, the oxidizing agent can be introduced first and, optionally after evaporating of the solvent, the thiophene or thiophene derivative can be introduced into the oxidized electrode body. The catalyst can be introduced in a separate step, for example before introduction of the oxidizing agent and thiophene or thiophene derivative, or together with one of the polymerization reactants. The same applies to the counterions. In order to ensure a long lifetime of the mixture in the case of use of mixtures of oxidizing agent and thiophene or thiophene derivatives, it may be advantageous to introduce the catalyst separately into the oxidized electrode body before the mixing or after the mixing.

It is also possible to add to the mixtures or reactants which are introduced into the oxidized electrode bodies further components such as one or more organic binders soluble in organic solvents, such as polyvinyl acetate, polycarbonate, polyvinyl butyral, polyacrylic esters, polymethacrylic esters, polystyrene, polyacrylonitrile, polyvinyl chloride, polybutadiene, polyisoprene, polyethers, polyesters, silicones, and styrene/acrylic ester, vinyl acetate/acrylic ester and ethylene/vinyl acetate copolymers, or water-soluble binders such as polyvinyl alcohols, crosslinkers such as melamine compounds, capped isocyanates, functional silanes—e.g. tetraethoxysilane, alkoxysilane hydrolyzates, for example based on tetraethoxysilane, epoxysilanes such as 3-glycidyloxypropyltrialkoxysilane—polyurethanes, polyacrylates or polyolefin dispersions, and/or additives, for example surface-active substances, for example ionic or nonionic surfactants or adhesion promoters, for example organofunctional silanes or hydrolyzates thereof, for example 3-glyciyloxypropyl-trialkoxysilane, 3-aminopropyltriethoxysilane, 3-mercaptopropyltrimethoxysilane, 3-methacryloyloxy-propyltrimethoxysilane, vinyltrimethoxysilane, octyl-triethoxysilane.

The application onto the dielectric of the electrode body can be effected directly or using an adhesion promoter, for example a silane, for example organofunctional silanes or hydrolyzates thereof, for example 3-glycidyloxypropyltrialkoxysilane, 3-amino-propyltriethoxysilane, 3-mercaptopropyltrimethoxy-silane, 3-methacryloyloxypropyltrimethoxysilane, vinyl-trimethoxysilane or octyltriethoxysilane, and/or one or more other functional layers.

The mixtures contain preferably from 1 to 30% by weight of the thiophene or thiophene derivatives and from 0 to 50% by weight of binders, crosslinkers and/or additives, both percentages by weight being based on the total weight of the mixture.

The mixture or the polymerization reactants are applied to the oxidized electrode body by known processes, for example by impregnation, casting, dropwise application, spray application, knife-coating, painting, spin-coating or printing, for example inkjet, screen, contact or pad printing.

After the mixture or polymerization reactants have been applied, the polymerization is accelerated by a thermal treatment at temperatures of from −10 to 300° C., preferably 10 to 200° C., more preferably 30 to 150° C. Depending on the type of polymer used for the coating, the duration of the thermal treatment is 5 seconds to several hours. For the thermal treatment, it is also possible to use temperature profiles with different temperatures and residence times.

The thermal treatment can be performed, for example, in such a way that the coated oxidized electrode bodies are moved through a heat chamber at the desired temperature at such a rate that the desired residence time at the selected temperature is achieved, or is contacted with a hotplate at the desired temperature for the desired residence time. In addition, the thermal treatment can be effected, for example, in a heated oven or several heated ovens with different temperatures in each case.

After the polymerization, it may be advantageous to wash the excess oxidizing agent and residual salts out of the coating with a suitable solvent, preferably water or alcohols. Residual salts are understood here, for example, to mean the products from the reduction of the oxidizing agent and any salts present.

For metal oxide dielectrics, for example the oxides of the valve metals, it may be advantageous, after the polymerization and preferably during or after the washing, to electrochemically reform the oxide film in order to correct any defects in the oxide film and thus to lower the residual current of the finished capacitor. In this so-called reforming, the capacitor body is immersed into an electrolyte and a positive charge is placed on the electrode body. The flowing current reforms the oxide at defect sites in the oxide film, and destroys conductive polymer at defects through which a high current flows.

According to the type of oxidized electrode body, it may be advantageous to impregnate the oxidized electrode body further times with the mixtures or polymerization reactants before and/or after a washing operation, in order to achieve thicker polymer layers in the interior of the electrode body. The compositions of the mixtures or polymerization reactants may be different. The solid electrolyte may optionally be formed from a multilayer system which comprises a plurality of functional layers.

After production of the solid electrolyte, further layers can optionally be applied to the capacitor body.

The electrode material of the capacitor is preferably a valve metal or a compound with comparable properties.

In the context of the invention, valve metals are understood to mean those metals whose oxide layers do not enable current flow equally in both directions: in the case of anodic application of voltage, the oxide layers of the valve metals block current flow, while, in the case of cathodic application of voltage, there are large currents which can destroy the oxide layer. The valve metals include Be, Mg, Al, Ge, Si, Sn, Sb, Hi, Ti, Zr, Hf, V, Nb, Ta and W, and also an alloy or compound of at least one of these metals with other elements. The best known representatives of the valve metals are Al, Ta and Nb. Compounds with comparable properties are those which have metallic conductivity and are oxidizable, and whose oxide layers possess the above-described properties. For example, NbO possesses metallic conductivity, but is generally not considered as a valve metal. Layers of oxidized NbO, however, have the typical properties of valve metal oxide layers, such that NbO or an alloy or compound of NbO with other elements are typical examples of such compounds with comparable properties.

Accordingly, the term “oxidizable metal” includes not just metals but also an alloy or compound of a metal with other elements, provided that they possess metallic conductivity and are oxidizable.

Particularly preferred valve metals or compounds with comparable properties are tantalum, niobium, aluminum, titanium, zirconium, hafnium, vanadium, an alloy or compound of at least one of these metals with other elements, NbO or an alloy or compound of NbO with other elements.

The dielectric consists preferably of an oxide of the electrode material or—if the latter is already an oxide—of a more highly oxidized form of the electrode material. It optionally contains further elements and/or compounds.

The oxidizable metals are sintered, for example in powder form, to give a porous electrode body, or a porous structure is imparted to a metallic body. The latter can be effected, for example, by etching a foil.

The porous electrode bodies are, for example, oxidized in a suitable electrolyte, for example phosphoric acid, by applying a voltage. The magnitude of this forming voltage depends on the oxide layer thickness to be achieved and the later use voltage of the capacitor. Preferred voltages are from 1 to 300 V, more preferably from 1 to 80 V.

The electrolyte capacitors produced by the process according to the invention are outstandingly suitable, owing to their low residual current and their low ESR, as a component in electronic circuits. Preference is given to digital electronic circuits, as are present, for example, in computers (desktops, laptops, servers), in portable electronic equipment, for example cellphones and digital cameras, in entertainment electronics equipment, for example in CD/DVD players and computer games consoles, in navigation systems and in telecommunications equipment.

The present invention therefore further provides electrolyte capacitors produced by the process according to the invention, and for the use of these electrolyte capacitors in electronic circuits.

The examples which follow serve to illustrate the invention by way of example and should not be interpreted as a restriction.

### EXAMPLES

### Example 1

### In situ Polymerization of 3,4-ethylenedioxythiophene (EDT) with tert-butyl hydroperoxide and di-tert-butyl peroxide as Oxidizing Agents

0.41 g of a 10% solution of tert-butyl hydroperoxide in ethanol, 0.17 g of a 15% solution of di-tert-butyl peroxide in ethanol, 0.8 g of a 10% solution of EDT in ethanol, 1.43 g of a 30% solution of p-toluenesulfonic acid monohydrate in ethanol and 0.48 g of a 0.5% solution of iron(III) toluenesulfonate in ethanol were mixed and knife-coated onto a polycarbonate film with wet film thickness 12 μm. Drying at 85° C. for 1 h was followed by brief washing with water; thereafter, a conductive blue film with a surface resistivity of 25.7 kΩ/sq was obtained.

### Example 2

### In situ Polymerization of 3,4-ethylenedioxythiophene (EDT) with tert-butyl hydroperoxide as the Oxidizing Agent

0.18 g of a 5.5 molar solution of tert-butyl hydroperoxide in nonane, 0.5 g of a 20% solution of EDT in ethanol, 1.07 g of a 50% solution of p-toluene-sulfonic acid monohydrate in ethanol and 0.60 g of a 1% solution of iron(III) toluenesulfonate in ethanol were mixed and knife-coated onto a polycarbonate film with wet film thickness 12 μm. Drying at 85° C. for 1 h was followed by brief washing with water; thereafter, a conductive blue film with a surface resistivity of 1.63 kΩ/sq was obtained.

### Example 3

### In situ Polymerization of EDT with tetra-n-butyl-ammonium peroxodisulfate as the Oxidizing Agent

0.60 g of tetra-n-butylammonium peroxodisulfate, 0.5 g of a 20% solution of EDT in ethanol, 1.33 g of a 50% solution of p-toluenesulfonic acid monohydrate in ethanol and 0.34 g of a 1% solution of iron(III) toluenesulfonate in ethanol were mixed and knife-coated onto a polycarbonate film with wet film thickness 12 μm. Drying at 85° C. for 1 h was followed by brief washing with water; thereafter, a conductive blue film with a surface resistivity of 5.37 kΩ/sq was obtained.

### Example 4

### Polymerization of EDT in Organic Solution with a Perester as the Oxidizing Agent

97 g of xylene, 9.21 g of dinonylnaphthalenesulfonic acid, 0.71 g of ethylenedioxythiophene (EDT) and 1.36 g of tert-butyl peroxybenzoate are stirred vigorously at 23° C. in a flask. The mixture is admixed with one drop of a 60% solution of iron(III) p-toluenesulfonate in butanol and changes color within a short time through purple to blue. The mixture is stirred for 4 h and then admixed with a further 332 g of xylene. After stirring for a further 2 h, the mixture is filtered through a fluted filter. The product obtained is a dark blue solution/dispersion and a dark blue precipitate. A pellet of the precipitate exhibits an electrical conductivity of 3×10⁻⁷ S/cm. The filtered solution can be knife-coated onto glass as a moderately conductive film.

### Comparative Example 1

### In situ Polymerization of 3,4-ethylenedioxythiophene (EDT) with dibenzoyl peroxide as the Oxidizing Agent

0.85 g of a 40% solution of dibenzoyl peroxide in dibutyl phthalate, 0.8 g of a 20% solution of EDT in ethanol, 2.13 g of a 50% solution of p-toluenesulfonic acid monohydrate in ethanol and 0.11 g of a 5% solution of iron(III) toluenesulfonate in ethanol were mixed and knife-coated onto a polycarbonate film with wet film thickness 12 μm. Drying at 85° C. for 1 h was followed by brief washing with water; thereafter, a streaky, gray, irregular film was obtained. Owing to the irregularity of the film, no conductivity could be measured.

The comparative example shows clearly that dibenzoyl peroxide is unsuitable as an oxidizing agent for the in situ deposition of polythiophenes.

### Comparative Example 2

### In situ Polymerization of 3,4-ethylenedioxythiophene (EDT) with dibenzoyl peroxide as the Oxidizing Agent

1.04 g of a 15% solution of 75% dibenzoyl peroxide (residual component: water) in acetone, 0.5 g of a 10% solution of EDT in ethanol, 1.34 g of a 20% solution of p-toluenesulfonic acid monohydrate in ethanol and 0.3 g of a 0.5% solution of iron(III) toluenesulfonate in ethanol were mixed and knife-coated onto a polyethylene terephthalate film with wet film thickness 12 μm. Drying at 85° C. for 1 h was followed by brief washing with water; thereafter, an irregular, streaky, blue-gray film with a surface resistivity of 2320 kΩ/sq was obtained.

The comparative example shows clearly that dibenzoyl peroxide is unsuitable as an oxidizing agent for the in situ deposition of polythiophenes.

1-20. (canceled)

21. A process for preparing polythiophene dispersions or for in situ deposition of polythiophenes which comprises oxidative polymerizing of a thiophene or thiophene derivative, wherein an oxidizing agent is used and is at least one organic peroxidic compound excluding diacyl peroxide.

22. The process as claimed in claim 21, wherein the polythiophene contains repeat units of the general formula (I) 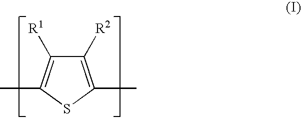
in which
R¹ and R² are each independently H, an optionally substituted C₁-C₁₈-alkyl radical or an optionally substituted C₁-C₁₈-alkoxy radical, or
R¹ and R² together are an optionally substituted C₁-C₈-alkylene radical, an optionally substituted C₁-C₈-alkylene radical in which one or more carbon atom(s) are optionally replaced by O, or are an optionally substituted propene-1,3-diyl in which the C-3 atom is optionally replaced by a heteroatom selected from O and S,
are prepared by oxidative polymerization of the thiophene of the general formula (II) 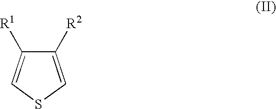
in which R¹ and R² are each as defined for the general formula (I).

23. The process as claimed in claim 21, wherein the polythiophene contains repeat units of the general formula (I-a) and/or (I-b) 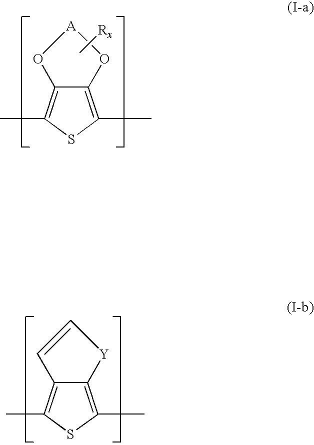
in which
A is an optionally substituted C₁-C₅-alkylene radical,
Y is O or S,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical an optionally substituted C₁-C₄-hydroxyalkyl radical or a hydroxyl radical,
x is an integer from 0 to 8, and
in the case that a plurality of R radicals are bonded to A, they may be the same or different,
are prepared by oxidatively polymerizing a thiophene of the general formula (II-a) and/or (II-b) 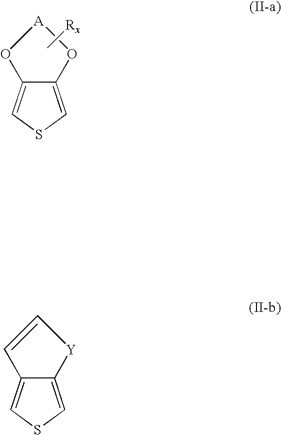
in which A, Y, R and x are each as defined above.

24. The process as claimed in claim 21, wherein a poly(3,4-ethylenedioxythiophene) is prepared by oxidatively polymerizing 3,4-ethylenedioxythiophene.

25. The process as claimed in claim 21, wherein the oxidizing agent is an organic peroxidic compound in which at least one —O—O— moiety is present.

26. The process as claimed in claim 21, wherein the oxidizing agent is a dialkyl peroxide, alkyl hydroperoxide, peracid, alkyl percarboxylate or alkyl percarbonate.

27. The process as claimed in claim 21, wherein the oxidizing agent is an organic salt of peroxodisulfuric acid or Caro's acid.

28. The process as claimed in claim 27, wherein the organic salt is an organically substituted ammonium or phosphonium salt of peroxodisulfuric acid.

29. The process as claimed in claim 28, wherein a monoalkyl ammonium salt of peroxodisulfuric acid, dialkyl ammonium salt of peroxodisulfuric acid, trialkyl ammonium salt of peroxodisulfuric acid, or tetraalkylammonium salt of peroxodisulfuric acid.

30. The process as claimed in claim 29, wherein the ammonium salt used is bis(tetra-n-butylammonium) peroxodisulfate [(n—C₄—H₉)₄N]₂S₂O₈.

31. The process as claimed in claim 21, wherein the oxidative polymerization is performed in the presence of at least one solvent.

32. The process as claimed in claim 21, wherein the oxidative polymerization is performed in the presence of at least one counterion.

33. The process as claimed in claim 21, wherein the oxidative polymerization is performed at temperatures of from −10 to 250° C.

34. The process as claimed in claim 21, wherein the thiophene and oxidizing agent are used in a weight ratio of from 4:1 to 1:20.

35. A process for preparing a dispersion comprising optionally substituted polythiophene which comprises oxidatively polymerizing an optionally substituted thiophene or thiophene derivative in the presence of at least one solvent and optionally of at least one counterion, wherein the oxidizing agent used is at least one organic peroxidic compound.

36. A process for producing a conductive layer comprising an optionally substituted polythiophene, which comprises oxidatively polymerizing an optionally substituted thiophene or thiophene derivative on a substrate with at least one organic peroxidic compound as an oxidizing agent in the presence or absence of at least one solvent.

37. A capacitor which comprises the conductive layer obtained by the process as claimed in claim 36.

38. A solid electrolyte which comprises the conductive layer obtained by the process as claimed in claim 36.

39. An electrolyte capacitor comprising a part obtainable by the process as claimed in claim 36.

40. An electronic circuit which comprises the electrolyte capacitor as claimed in claim 39.
